(19) United States
(12) Patent Application Publication
(10) Pub. No.: US 2011/0050162 A1
(43) Pub. Date: Mar. 3, 2011

(54) Fabric Power Panel Insert

(76) Inventor: Bruce FallHowe, Colorado Springs, CO (US)

(21) Appl. No.: 12/854,951

(22) Filed: Aug. 12, 2010

Related U.S. Application Data
(60) Provisional application No. 61/238,082, filed on Aug. 28, 2009.

(51) Int. Cl. H02J 7/00

(52) U.S. Cl. 320/107

(57) ABSTRACT

A fabric power panel insert for brief cases, backpacks and other luggage embedding a controller, battery pack, AC adapter, retractable power cord, a computer connector cord, 5 volt USB port and wires with connectors linking components. The fabric power pack provides a power system that enables the user to recharge both the mobile device batteries and the backup battery pack at the same time with one retractable power cord and AC adapter and then use the backup battery pack to provide reserve power for those mobile devices when the mobile device batteries lose their power. All of the components are embedded in the panel within fabric pockets that hold each component in a specific location with elastic straps and fabric tie downs. The panel is then inserted into the case and secured by hook and loop straps to hold it in the case.

### RELATED APPLICATIONS

The present invention claims priority on provisional patent application Ser. No. 61/238,082, filed on Aug. 28, 2009, entitled “Brief-case/backpack/luggage that contains a backup battery for cell phone and or notebook/netbook computers, includes an AC power adapter and connection interface for a cell phone, MP3, player or notebook/netbook computer (plug)” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Present day mobile devices such as mobile phones and lap top computers require a constant source of power for those devices to have utility. While battery life has improved, the frequency and duration of the use of the devices has also increased along with higher level application programs requiring more power. The net result is a constant search for a 110 volt power outlets and carrying a power cord with an AC adapter to recharge the mobile device. In addition, many users of such devices have more than one mobile device requiring multiple power cords and AC adapters because they have different voltage level requirements, and as a result, different AC adapters and connectors for each device.

The user has to remember to charge all mobile devices before their portable utility is needed and to carry all of the power cords and AC adapters if they need to recharge the devices while traveling, for example.

Ways to bridge the gap between the need for back up power and the constant demand for power have been attempted by designing back up batteries for each type of device with a power cord and AC adapter for that back up battery. This solution is less than elegant as it requires more hardware for each mobile device and a way to carry all of the additional power cords and AC adapters. The mobile devices have to be recharged and the backup batteries have to be separately recharged. In addition, the user may forget the power cords and AC adapter either at home or in the hotel room.

Thus there exists a need for a power panel that can charge or power all of a user's portable devices conveniently.

### BRIEF SUMMARY OF INVENTION

A fabric power panel insert that overcomes these and other problem has a controller that transcends the different voltage levels, and therefore, eliminates the need for multiple power cords and AC adapters, i.e., all mobile devices can be controlled, recharged, by one system. In addition, the controller allows the recharging of all of the mobile devices at the same time the back up battery pack is being recharged. This eliminates the need for multiple power cords and AC adapters for multiple mobile devices and backup batteries.

Since most mobile devices require some type of carrying case, the power panel is embedded in a fabric panel that inserts into an existing brief case or backpack or is part of a custom brief case or backpack. The fabric panel is designed to neatly integrate with a briefcase or backpack. The fabric panel contains the controller, the backup battery pack, the AC adapter with a retractable power cord and a connector cord for a computer and a USB port for a mobile device. Hence, by embedding all of the components into the fabric panel they become part of the carrying case allowing the user to have a power panel that recharges all of the mobile devices, recharges the backup battery back, and provides backup power thereby eliminating the need for the constant search of a power outlet. In addition, because the power panel is part of the carrying case the user is reminded to recharge all devices at the same time, along with the backup battery pack, with only one power cord and AC adapter. The power cord and AC adapter can not be forgotten or lost because they are embedded in the case.

### BRIEF DESCRIPTION OF THE SEVERAL VIEWS OF THE DRAWINGS

FIG. 1 is a perspective view of a briefcase with a fabric power panel insert in accordance with one embodiment of the invention;

FIG. 2A is a front view of a fabric power panel insert in accordance with one embodiment of the invention;

FIG. 2B is a side view of a fabric power panel insert in accordance with one embodiment of the invention;

FIG. 3 is a front view of a control panel in accordance with one embodiment of the invention;

FIG. 4 is a block diagram a power panel in accordance with one embodiment of the invention; and

FIG. 5 is a flow chart of the steps used in charging a device in accordance with one embodiment of the invention.

### DETAILED DESCRIPTION OF THE INVENTION

The invention is directed to a power panel system that includes an electrical storage device. A controller regulates both the charging of the electrical storage device and the voltage outputs from the electrical storage device. The electrical storage device and the controller fit inside a power panel, which may be a fabric housing. A number of adapter cables may also be held by the fabric housing for connecting to a variety of mobile devices. The controller allows the recharging of all of the mobile devices at the same time the back up battery pack is being recharged. This eliminates the need for multiple power cords and AC adapters for multiple mobile devices and backup batteries.

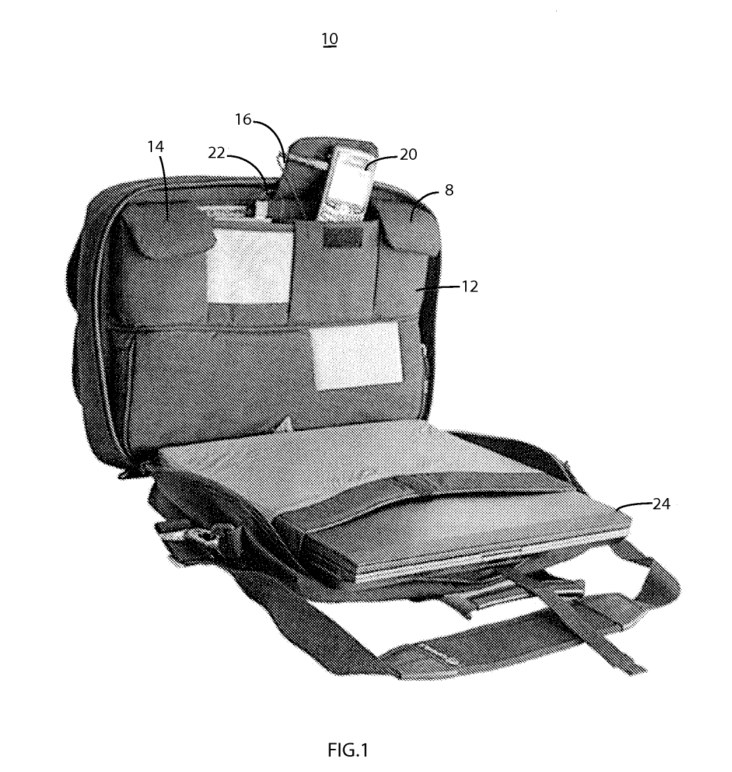

FIG. 1 is a perspective view of a briefcase 10 with a fabric power panel insert 12 in accordance with one embodiment of the invention. The fabric power panel 12 may be an integral part of the briefcase 10 or it may be removable attached to the briefcase 10. In one embodiment, hook and loop straps are used to connect the power panel 12 to the briefcase 10. The power panel 12 has a plurality of pockets 14, 16, 18 to hold mobile devices, such as a cellular telephone 20. The cellular telephone 20 is being charged using an adapter cable 22. In this embodiment, a notebook computer 24 is also the carrying case 10.

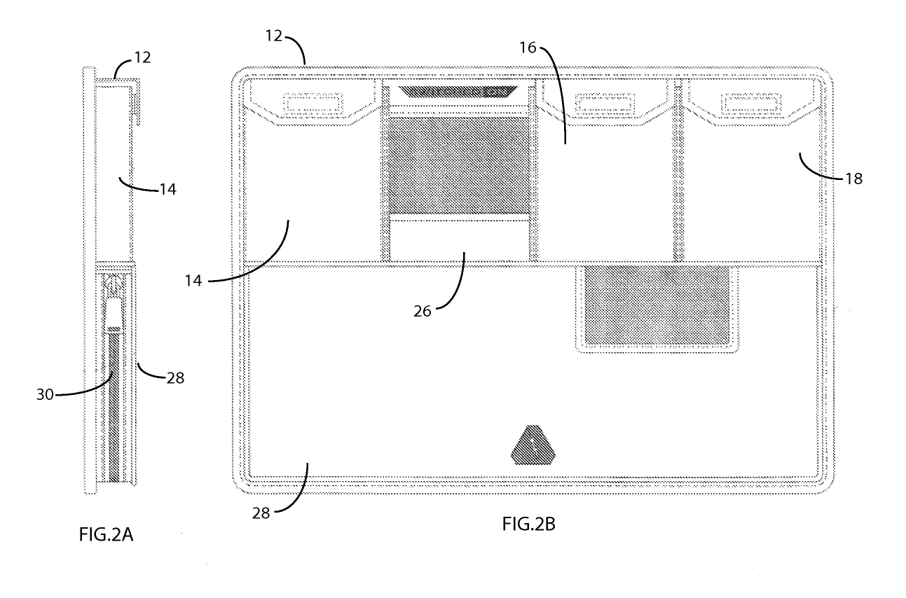

FIG. 2A is a front view of a fabric power panel insert 12 in accordance with one embodiment of the invention. The power panel 12 has a plurality of pockets 14, 16, 18 for holding portable devices such as MP3 players. The panel 26 contains an electronic control circuit. The lower panel 28 holds an electrical storage device such a rechargeable battery. FIG. 2B is a side view of a fabric power panel insert 12 in accordance with one embodiment of the invention. This embodiment shows that a zipper 30 provides access to the electrical storage device.

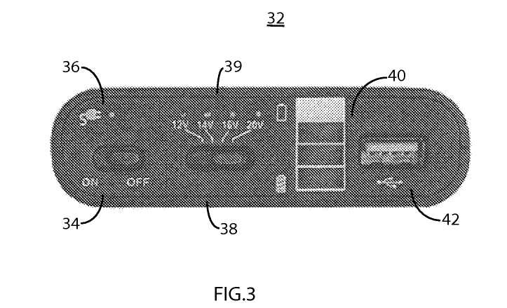

FIG. 3 is a front view of a control panel 32 in accordance with one embodiment of the invention. The control panel 32 regulates the electronic control circuit. The control panel 32 includes an on/off switch 34, a battery charging indicator 36, an output voltage selector 38, a battery charge indicator 40, and a USB (Universal Service Bus) port 42. When the power panel 12 is plugged into a 110 Volt outlet, the charging indictor light is on (red light) and when the battery or other electrical storage device is fully charged a green light is on. The output voltage selector 38 provides the option of selecting output voltages of twelve volts, fourteen volts, sixteen volts and twenty volts, in one embodiment, for the different laptop computer voltage requirements. The output voltage indicators 39 confirm the voltage selected. The output voltage indicators 39 are LEDs (Light Emitting Diodes) in one embodiment. The charge indicator 40 displays the charge left in the power panel 12. The USB port 42 provides a five volt output to charge cellular telephones, MP3 players, and similar devices.

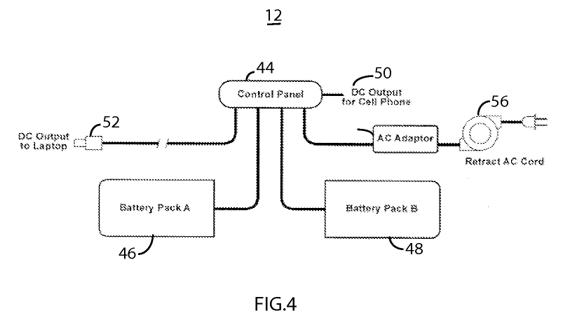

FIG. 4 is a block diagram a power panel 12 in accordance with one embodiment of the invention. The power panel 12 has a control circuit and panel 44. A plurality of batteries 46, 48 are connected to the control circuit and panel 44. The control circuit and panel 44 contains a microprocessor that controls the charging of the battery packs 46, 48, the charging of the mobile devices 50, the charging of computer 52 and monitors the power supply/AC adapter 54 to prevent over charging when all batteries are fully charged. The power panel 12 has a single AC adapter 54, which makes it more convenient and cost effective than present charging solutions that require multiple AC adapters. A retractable power cord 56 is attached to the AC adapter 54. The retractable power cord 56 fits inside the soft sided housing of the power panel for convenience. The DC output cord to the laptop computer 52 may also be retractable. A number of adapters may come with the fabric power panel insert 12 to connect to a variety of different notebook/netbook computers.

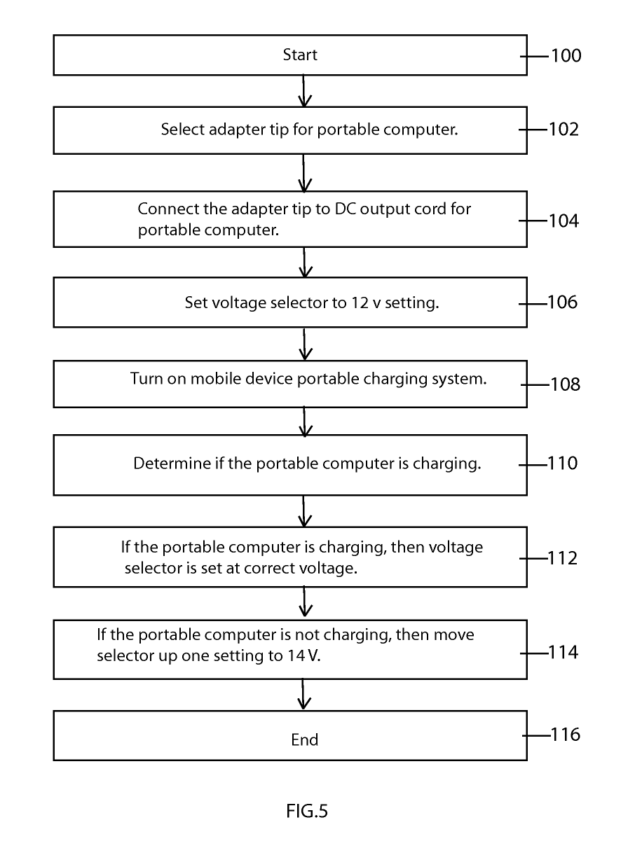

FIG. 5 is a flow chart of the steps used in charging a device in accordance with one embodiment of the invention. The process starts, step 100, by selecting adapter tip for portable computer at step 102. Next the adapter tip is connected to DC output cord for portable computer at step 104. The voltage selector is set to the lowest setting, twelve volts in one embodiment at step 106. The mobile device portable charging system is turned on at step 108. Next it is determined if the portable computer is charging at step 110. This can be determined by examining whether a charging indicator of the portable computer is on. If the portable computer is charging at step 112, then the voltage selector is correct and the process ends at step 116. If the portable computer is not charging at step 114, then the voltage selector is moved up to the next setting and the process is repeated until the portable computer is charging.

Thus there has been described a fabric power panel insert that can charge or power all of a user's portable devices conveniently.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A mobile device portable charging system, comprising:
a power panel having a handle and an interior storage space;
an electrical storage device enclosed in the housing;
an electronic control circuit electrically powered by the electrical storage device having voltage selector; and
a plurality of electrical connectors in electrical communication with the electronic control circuit.

2. The system of claim 1, wherein the electronic control circuit is enclosed in the housing;

3. The system of claim 1, wherein the plurality of electrical connectors includes a standard AC power cord.

4. The system of claim 1, wherein the plurality of electrical connectors includes a mobile telephone connector.

5. The system of claim 4, wherein the plurality of electrical connectors includes a portable computer connector.

6. The system of claim 3, wherein the standard AC power cord is retractable.

7. The system of claim 1, wherein the electronic control circuit includes a single AC power adapter.

8. A mobile device portable charging system, comprising:
a soft sided power panel having an interior space accessible through an access/closure device;
an electrical storage device in an interior pocket of the case;
an electronic control circuit regulating an input and an output of electrical energy into the electrical storage device;
an electronic control panel controlling a setting for the electronic control circuit; and
an electrical power cord attached to the electronic control circuit.

9. The system of claim 8, wherein the electronic control panel includes an output voltage selector.

10. The system of claim 9, wherein the electronic control circuit has a single AC power adapter.

11. The system of claim 10, wherein the electronic control panel includes a USB power jack.

12. The system of claim 8, wherein the electrical storage device is a lithium polymer battery.

13. The system of claim 8, wherein the electronic control circuit includes a battery charging circuit.

14. The system of claim 8, wherein the electrical power cord is retractable.

15. A mobile device portable charging system, comprising:
an electrical storage device;
an electronic control circuit regulating an energy input and an energy output to the electrical storage device;
an electrical power cord attached to the electronic control circuit;
an electrical power output jack connected to the electronic control circuit; and
a fabric power panel holding the electrical storage device.

16. The system of claim 15, further including an electronic control panel controlling a state of the electronic control circuit

17. The system of claim 16, wherein the electronic control panel includes an output voltage selector.

18. The system of claim 17, wherein the electronic control panel includes a power on switch.

19. The system of claim 18, wherein the electronic control panel includes a USB power jack.

20. The system of claim 19, wherein the electronic control circuit has a single AC power adapter.
